(19) United States
(12) Patent Application Publication
(10) Pub. No.: US 2007/0013871 A1
(43) Pub. Date: Jan. 18, 2007

(54) Light-emitting diode (LED) illumination in display systems using spatial light modulators (SLM)

(76) Inventors: Stephen Wesley Marshall, Richardson, TX (US); Steven Monroe Penn, Plano, TX (US)

Correspondence Address: TEXAS INSTRUMENTS INCORPORATED, P O BOX 655474, M/S 3999, DALLAS, TX, 75265, US

(21) Appl. No.: 11/182,246

(22) Filed: Jul. 15, 2005

(51) Int. Cl. G03B 21/14

(52) U.S. Cl. 353/20; 353/38

(57) ABSTRACT

System and method for enhancing performance in an SLM display system using LED illumination. A preferred embodiment comprises computing a set of spectral characteristics, analyzing the set of spectral characteristics, and modulating a light produced by a light source of a display system based upon the analysis, wherein the light source comprises one or more light-emitting diodes. The spectral characteristics can provide information regarding either the images being displayed by the display system or an operating environment of the display system. Either can have an impact upon the quality of the images being displayed on the display system and can be used to make adjustments to the light source.

### TECHNICAL FIELD

The present invention relates generally to a system and method for display systems, and more particularly to a system and method for enhancing performance in an SLM display system using LED illumination.

### BACKGROUND

Display systems using spatial light modulators (SLM), such as digital micromirror devices (DMD), liquid crystal display (LCD), liquid crystal on silicon (LCoS), deformable mirrors, and so forth, typically use light sources that are continually on to display an image (or a sequence of images) on a display screen. These light sources normally are turned on when the display system is powered on and remain on until the display system is turned off due to their slow on-off cycle times. The light sources, such as ultra-high-pressure (UHP) arc lamps, have a broadband visible light spectrum and require the use of color filters to selectively transmit desired color sequences to the SLM. These light sources can be extremely bright and can have long life. Therefore, they are the illumination source of choice in many display systems.

One disadvantage of the prior art is that in addition to being continually on, the light sources will usually be only capable of producing light at a single intensity level. Therefore, in order to reduce light incident on the SLM, filters and/or apertures may be required to attenuate the light on the SLM to enable increased display system bit-depth. The addition of the filters and/or apertures can increase display system complexity, which can lead to increased cost as well as decreased reliability.

A second disadvantage of the prior art is that since the light source is always on, even when not needed, there is an inefficient use of electrical power. This inefficient use of electrical power can preclude the use of batteries to power the display systems that use these light sources, preventing the creation of mobile display systems. Furthermore, the inability of the light source to turn on and off rapidly can limit a shortest duration of light producible by the display system. This can place a limit on a number of displayable gray shades (or contrast ratio) and compromise image quality.

Yet another disadvantage of the prior art is that since the intensity of the light source cannot be changed, in situations where dark images are being displayed, light scattered from structures within the SLM can significantly reduce achievable contrast ratio. This can lead to low quality images, especially for images with a large percentage of dark information.

### SUMMARY OF THE INVENTION

These and other problems are generally solved or circumvented, and technical advantages are generally achieved, by preferred embodiments of the present invention which provides a system and method for enhancing performance in an SLM display system using LED illumination.

In accordance with a preferred embodiment of the present invention, a method for operating a display system is provided. The method includes computing a set of spectral characteristics, analyzing the set of spectral characteristics, and modulating a light produced by a light source of the display system based upon the analysis. The light source of the display system is capable of rapid switching and is modulatable.

In accordance with another preferred embodiment of the present invention, a display system is provided. The display system includes a spatial light modulator, with the spatial light modulator being configured to create images made up of pixels by setting each light modulator in an array of light modulators into a state matching a corresponding pixel value, and a rapid switching and modulatable light source (RSMLS) to optically illuminate the spatial light modulator, with the RSMLS being capable of switching at a faster rate than a rate of state switching for the light modulators in the spatial light modulator and producing a light of specifiable intensity and color.

An advantage of a preferred embodiment of the present invention is that the use of a rapid switching light source (LED) can result in an increase in the dynamic range (bit-depth) of the display system. This can result in a greater number of gray shades and hence, improve image quality. The performance of the display system can also be improved due to more accurate control of bit times.

A further advantage of a preferred embodiment of the present invention is that the light produced by the LED can be decreased for dark images, which can lead to an increased contrast ratio, which will also result in improved image quality. Furthermore, the ability to decrease the intensity of the light produced by the LED can be achieved without the use of dynamic apertures or neutral density filters, which tend to increase display system complexity and cost.

Yet another advantage of a preferred embodiment of the present invention is reduced power consumption by reducing light output when the display system is using battery power. This can enable mobile applications with good battery life.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a prior art display system;

FIGS. 2a through 2c are diagrams of arrangements of LEDs, according to a preferred embodiment of the present invention;

FIG. 3 is a diagram of a light source for a display system, wherein multiple LEDs are used to provide light, according to a preferred embodiment of the present invention;

FIGS. 4a and 4b are diagrams of different techniques for modulating light from the light source of a display system, according to a preferred embodiment of the present invention;

FIGS. 5a through 5e are diagrams of different light modulating techniques making use of spectral characteristics, according to a preferred embodiment of the present invention; and

FIG. 6 is a diagram of a display system, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an SLM display system making use of digital micromirror devices as light modulators. The invention may also be applied, however, to other SLM display systems, such as those making use of LCD, LCoS, deformable mirrors, and so forth.

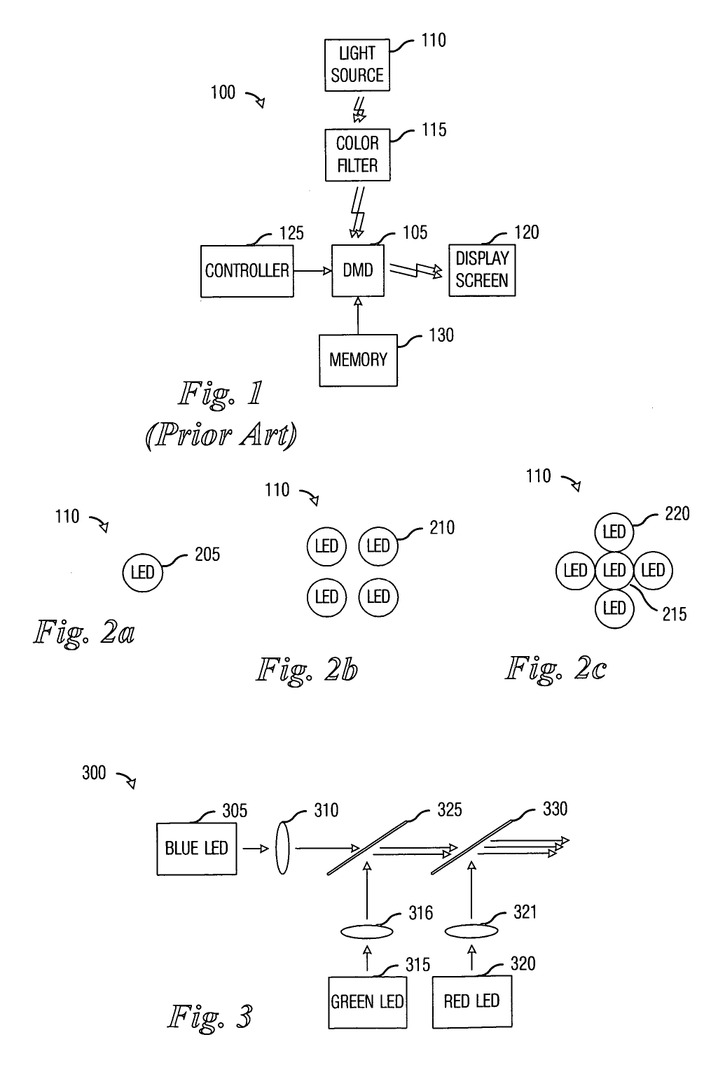

With reference now to FIG. 1, there is shown a diagram of a prior art display system 100. The display system 100 features a digital micromirror device (DMD) 105 as a light modulator. The DMD 105 comprises an array of positional micromirrors that can change state (position) depending upon an image being displayed. The DMD 105 reflects colored light that is produced by a light source 110 and filtered by one or more color filters 115 either away from or towards a display screen 120. Light reflected away from the display screen 120 will show up as dark portions of the image, while light reflected towards the display screen will show up as lighted portions of the image. The array of positional micromirrors can be controlled by a controller 125, which can issue commands to control the state of the micromirrors. For example, the controller 125 can command the positional micromirrors to assume a state specified by pixels in the image being displayed, return to a reset position, or so forth. The pixel data of the image(s) to be displayed can be stored in a memory 130.

The light source 110 can be a UHP arc lamp, which is capable of producing a bright, broad-spectrum light. Since the light produced by the UHP arc lamps are broad-spectrum, the color filter 115 is needed to produce desired colors, such as green, blue, and red. The UHP arc lamp can be replaced by light-emitting diodes (LEDs), LEDs with phosphor coatings, or lasers. The LED replacing the UHP arc lamp can also produce a broad-spectrum light (white) or narrow-spectrum light at desired colors, such as green, blue, or red, for example. Since LEDs are inherently narrow-spectrum devices, to provide broad-spectrum LEDs, a phosphor coating can be added. A single LED can replace the UHP arc lamp or multiple LEDs can be used in place of the UHP arc lamp.

With reference now to FIGS. 2a through 2c, there are shown diagrams illustrating LED arrangements usable as light sources in a display system, according to a preferred embodiment of the present invention. The diagram shown in FIG. 2a illustrates a single LED 205 usable as a light source 110 in a display system. The LED 205 can be a broad-spectrum LED, which may require the use of a color filter 115 to provide a desired color of light, or narrow-spectrum LED, which may not require the use of the color filter 115. The diagrams shown in FIGS. 2b and 2c illustrate multiple LEDs, such as LED 210 (FIG. 2b) and LED 215 (FIG. 2c), usable as a light source 110 in a display system. The use of multiple LEDs can allow for the ability to produce light at a greater intensity than that possible with a single LED, produce light with a wide range of intensities (by turning on or off more than one LED, in addition to changing the intensity of light produced by a single LED), or make use of narrow-spectrum LEDs which can preclude the need of the color filter 115. The multiple LEDs can be arranged in a grid, such as a 2×2 grid shown in FIG. 2b, or in an arrangement wherein a LED 215 is surrounded by a plurality of LEDs, such as LED 220, as shown in FIG. 2c.

In situations where multiple LEDs are used as a light source 110, the LEDs can produce the same type of light or the LEDs can produce different colored light. For example, in an arrangement as shown in FIG. 2c, the LED 215 may produce a broad-spectrum light, while the LEDs 220 can produce narrow-spectrum light, such as two of the LEDs 220 can produce green colored light, one of the LEDs 220 can produce blue colored light, and one of the LEDs 220 can produce red colored light. The example above is intended to be an illustration of a possible implementation of a light source using multiple LEDs and should not be construed as being limiting to the spirit or scope of the present invention.

With reference now to FIG. 3, there is shown a diagram illustrating an exemplary light source 300 for a display system, wherein multiple LEDs are used to provide light, according to a preferred embodiment of the present invention. The light source 300 comprises separate LEDs for each of three component colors, RGB (red, green, and blue). The use of narrow-spectrum LEDs can enable the deletion of a color filter 115 (FIG. 1), as well as enable the individual manipulation of the component colors. A series of lenses and filters can then be used to focus and combine the three component colors. For example, blue LED 305 produces blue colored light that can be focused by a lens 310, while a green LED 315 produces green colored light and a red LED 320 produces red colored light. Lenses 316 and 321 focus light from the green LED 315 and red LED 320, respectively.

Focused light from the lenses can be combined by filters. For example, a filter 325 can be used to combine focused light from the blue LED 305 and the green LED 315. The filter 325 can transmit light in the blue spectrum while reflecting light in the green spectrum. The filter 325 may also filter a portion of the blue spectrum to regulate the type of blue light being provided to the display system. A filter 330 can transmit light from the blue and the green spectrum while reflecting light in the red spectrum. Additionally, the filter 330 can filter a portion of the green spectrum in order to regulate the type of green light being provided to the display system. The arrangement of the LEDs, filters, and lenses can be dependent upon a desired composition of the light being provided to the display system.

Although referred to as single LEDs, the blue LED 305, the green LED 315, and the red LED 320 may actually comprise a plurality of LEDs. The actual number of LEDs present in each one of the LEDs may be dependent upon factors such as desired light intensity for light within the various spectra, the amount of light producible within a certain spectrum, desired display system performance, and so forth, with a possibility of a different number of LEDs being used for each color light. For example, if LEDs producing green colored light are brighter than LEDs producing blue colored light, then it can be possible to use a smaller number of green LEDs than blue LEDs. Additionally, instead of using narrow-spectrum LEDs, broad-spectrum LEDs can be used in conjunction with color filters to provide desired colored light.

The ability to modulate the light produced by an LED or multiple LEDs used as a light source in a display system is a significant advantage of the use of an LED. The light produced by an LED can be modulated in several different ways. A first way to modulate the light produced by an LED is to turn the light on or off. The use of an LED can allow the light source to be rapidly turned on and off, whereas the use of UHP arc lamps typically preclude the switching of the lamp state except at display system power on or off. A second way to modulate the light produced by an LED is to vary the intensity of the light. Both modulation techniques can lead to an increase in a number of gray shades displayable by the display system as well as increasing the display system's contrast ratio by reducing scattered light in dark images. Furthermore, by reducing the intensity of the light produced by the LED or by turning the LED off, power consumption can be reduced. This can lead to longer light source life as well as increased display time for mobile applications wherein the display system may be powered by batteries. Additionally, light within certain spectra can be varied to improve image quality. This can be dependent upon the characteristics of the images themselves and/or the environment in which the display system is being used.

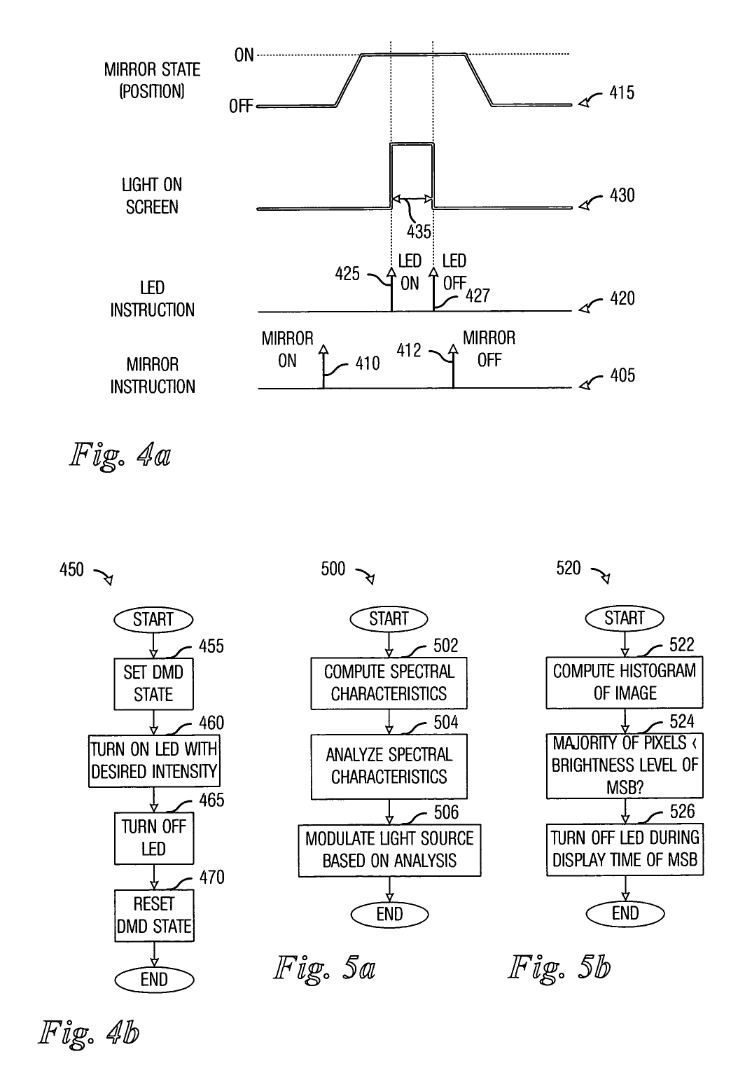

With reference now to FIGS. 4a and 4b, there are shown diagrams illustrating the modulation of light produced by a light source of a display system by turning an LED on and off and by controlling an intensity of light produced by an LED, according to a preferred embodiment of the present invention. The diagram shown in FIG. 4a illustrates the modulation of light produced by the light source by turning the LED on and off. In a display system that makes use of a permanently on light source and spatial light modulators to modulate the light produced by the light source, such as a display system making use of DMDs, deformable mirrors, LCDs, and so forth, there is a minimum amount of time that is required for the spatial light modulators to attain a desired state. For example, in a display system using DMDs, there is a mirror flight time that can be described as an amount of time required for a micromirror to change states (to move from a first state to a second state). An effective light time (ELT) can be defined based on the mirror flight time and can be equal to a time that is required for a micromirror to switch from the first state to the second state and back to the first state. The ELT is the minimum amount of light displayable by the display system. Typically, if it is desired to display less light, the use of additional techniques such as neutral density filters and/or adaptive apertures may be necessary. However, using an LED's ability to rapidly turn on and off, it can be possible to display less light than the ELT without having to add extra hardware to the display system.

A first trace 405 illustrates mirror instructions provided by a controller, such as a sequence controller, in a display system that can be used to control mirror state. For example, a first mirror instruction 410 can result in a mirror being moved into an ON state and a second mirror instruction 412 can result in a mirror being moved into an OFF state. The state of the mirror can actually be related to a position of a mirror, with an ON state having the mirror in a position wherein light from the light source is reflecting onto a display screen and an OFF state having the mirror in a position wherein light from the light source is not reflecting onto the display screen. The mirror instructions from the controller are actually provided to each mirror in the DMD and the position of each of the mirrors is dependent upon a value of a pixel that corresponds to the mirror. For example, if a pixel's value is OFF, then a corresponding mirror will move to the OFF position when a mirror instruction instructs the mirrors to assume their pixel value.

When the mirror receives a mirror instruction to assume a value corresponding to its pixel value, the mirror can begin movement. However, since the mirror is a mechanical device, the mirror cannot move instantaneously to the desired value. A second trace 415 illustrates mirror position as a function of time. Due to mirror inertia, the mirror does not begin to move until a period of time after the issuance of the first mirror instruction 410. As the mirror begins to move, there is a transition between the mirror's OFF position and the mirror's ON position. Some time after the issuance of the first mirror instruction 410, the mirror completes its transition into the ON position. After the issuance of the second mirror instruction 412, the mirror moves back into the OFF position from the ON position. The second trace 415 illustrates an idealized motion taken by the mirror and does not show any ringing, overshoot, vibrations, and so forth that may actually be present in the movement of the mirror.

If the light source of the display system is on, then as the mirror approaches the ON position, light from the light source will begin to display on the display screen. However, with the use of LEDs, the light source can be off while the mirror is moving into the ON position. To display less light than a smallest ELT, some time after the mirror has moved into the ON position, the LED can be turned on. A third trace 420 illustrates LED instructions. A first LED instruction 425 can turn on the LEDs in the light source and a second LED instruction 427 can turn off the LEDs in the light source. A fourth trace 430 illustrates an effective light time (shown as span 435) that is less than achievable using the mirror position alone. The illustrated example shown in FIG. 4a displays the light source being turned on and off while the mirror is in the ON state. It is also possible to overlap light source turn on or turn off with the state transition of the mirror if the LEDs in the light source exhibit unusual (or unexpected) behavior during turn on or turn off, such as long turn on or turn off transition times, irregular light output during transition, and so forth.

In addition to modulating the light produced by the light source by turning the light source on and off, a preferred embodiment of the present invention can also modulate the light produced by the light source by changing the intensity of the light produced by the light source. The use of LEDs in the light source can permit the changing of the intensity of the light by changing the intensity of the light produced by the LEDs themselves (by changing a drive current provided to the LEDs) or by changing a number of LEDs being driven by the drive current. Changing the intensity of the light produced by the light source can be accomplished with the addition of an extra LED instruction or with an additional argument to an existing LED instruction.

The diagram shown in FIG. 4b illustrates a sequence of events 450 in the display of a pixel value by a DMD, wherein the intensity of the light produced by the light source is specified by the controller. The sequence of events 450 can begin with a setting of a desired state for the DMD (block 455). This can be achieved with a mirror instruction, such as the first mirror instruction 410 (FIG. 4a). The first mirror instruction 410 can result in the mirrors of the DMD assuming a state corresponding to pixel values that they are assigned to display, for example, if a pixel value is OFF, then the corresponding mirror can move to an OFF position and if a pixel value is ON, then the corresponding mirror can move to an ON position. After the issuance of the instruction for setting the state of the DMD (block 455), an LED instruction can be issued to set the light source to produce light with a specified intensity (block 460). The LED instruction to set the light output intensity of the light source can be implemented in several different ways.

A first implementation of the LED instruction may be a unique LED instruction that specifies a desired output light intensity. If the light source is already on, then the issuance of the LED instruction can result in a change in the light produced by the light source. However, if the light source is not on, then the light source may remain off until an LED instruction turning on the LED is issued. After issuance of the instruction specifying the desired output light intensity, an instruction turning on the LED may be issued. A second implementation of the LED instruction may be a modification to an LED instruction used to turn on the LED. The modified LED turn on instruction may include an argument specifying the desired output light intensity.

After the light source has been turned on with the desired output light intensity (block 460), then the light source may be turned off after a specified duration of time has expired (block 465). The turning off of the light source (block 465) may be omitted if a mirror instruction to reset the DMD state is issued (block 470). If the DMD state is reset, the mirrors in the DMD move to an off position, which can effectively stop the display of light on the display screen. In practice, an actual sequence of LED instructions and mirror instructions can be dependent upon pixels being displayed before and after a current pixel being displayed. For example, if in displaying a previous pixel, the light source is left in an on state with an output light intensity matching the desired output light intensity, then it can be possible to omit the LED instruction(s) issued in block 460. Additionally, if in displaying a subsequent bit, it is possible to leave the light source in an on state, then it can be possible to omit the LED instruction issued in block 465.

In addition to modulating the light produced by the light source in order to display a greater number of gray shades, decrease power consumption, improve contrast ratio, and so forth, the modulation of the narrow-spectrum light produced by the LEDs in the light source can also be used to improve overall image quality by making use of spectral characteristics of the images being displayed or an environment wherein the images are being displayed.

With reference now to FIGS. 5a through 5e, there are shown diagrams illustrating sequences of events in the modulating of light produced by a light source of a display system using spectral characteristics of the images being displayed or an environment wherein the images are being displayed, according to a preferred embodiment of the present invention. The diagram shown in FIG. 5a illustrates a sequence of events 500 in the use of spectral characteristics to modulate light produced by the light source to help improve the image quality of the display system. The spectral characteristics can be of the images being displayed by the display system or of the environment wherein the display system is operating. The spectral characteristics can be computed by a controller, processing element, or custom integrated circuit of the display system and can be used to determine necessary modifications (modulations) to the light produced by the light source.

The sequence of events 500 can begin with a computation of the spectral characteristics (block 502). If the spectral characteristics are to be based upon images being displayed by the display system, the computation can simply take place on the images as they are being displayed. However, if the spectral characteristics are to be based upon the operating environment of the display system, a sensor, for example, an optical sensor, may be necessary to sample the operating environment. After the computation of the spectral characteristics, an analysis of the spectral characteristics can be performed (block 504). According to a preferred embodiment of the present invention, the analysis of the spectral characteristics can be performed by the controller, processing element, or custom integrated circuit. Analytical algorithms and models can be implemented via software, hardware, or firmware to analyze the spectral characteristics to determine what (if any) modifications can be made to the light produced by the light source to improve image quality and/or reduce power consumption.

Based upon results of the analysis of the spectral characteristics (block 504), it can then be possible to modulate the light source (block 506). The modulations to the light source can include changing the intensity of the light produced by the light source in a broad-spectrum manner (all color components at a time), turning the light source off for certain periods of time, changing the intensity of the light produced by the light source in a narrow-spectrum manner (one color component at a time), changing a percentage of a color component in the light (to change the hue, for example), and so forth.

The diagram shown in FIG. 5b illustrates a sequence of events 520 in the use of the spectral characteristics of an image being displayed to modulate the light produced by the light source, wherein the light source is turned off to improve the contrast ratio of the image being displayed. According to a preferred embodiment of the present invention, the spectral characteristics of the image can be determined by computing a histogram of the image. The histogram of an image can provide information such as a number of pixels in an image at various intensities (or displayable gray shade). There may be a single histogram for an image or there may be a histogram for each color component of the image, such as a histogram for each of the three RGB components. The computation of the histogram of an image can be performed by a processor or controller located in the display system. Alternatively, a custom designed integrated circuit can be used to compute the histogram of the image.

The sequence of events 520 can begin with the computation of a histogram of an image being displayed (block 522). The computation of the histogram can be performed by a controller, a processor, or a custom designed integrated circuit located in the display system. Since there may be a small processing time, the events illustrated in the sequence of events 520 may take place on an image that is not currently being displayed but a few images subsequent to the image being displayed. For example, the histogram may be computed for an image that may be the next image to be displayed or the second next image to be displayed. This may require that some of the images be buffered to prevent loss. However, if the processing can be performed in sufficient time, it can be possible to perform the processing on the image as it is being displayed. Once the histogram has been computed (block 522), a decision can be made based upon the histogram. If a majority of the pixels in the image have a brightness level that is less than the brightness level of the most significant bit (MSB) of the pixel bit planes (block 524), then the light source can be turned off when the display system is displaying the MSB pixel bit plane (block 526).

For example, assuming a simple binary weighting of the bits in the pixel bit plane, the decision of block 524 can be determining if a majority of the pixels have a brightness of less than 50 percent of maximum brightness. The decision can be extended to less significant bit planes as well. To determine if the MSB and a next MSB, referred to as the MSB-1 bit, can be turned off, the decision of block 524 can be determining if a majority of the pixels have a brightness of less than 25 percent of maximum brightness. Similar decisions can also be made if the pixel bit planes make use of non-binary weightings, therefore the use of the exemplary binary-weighting should not be construed as being limiting to the spirit and scope of the present invention.

Rather than instantaneously turning on or off the light source for each image, the light source can be ramped on or ramped off over several consecutive images. The ramp on or ramp off can further help improve image quality by reducing flickering that may occur with suddenly turning on or off the light source. Additionally, turning off the light source during the more significant bit planes may have a detrimental effect on image gray scale smoothness. Priority may be given to bit planes with lower significance. In such a scenario, the light source may be turned off during lower significance bit planes and turned on during high significance bit planes (as image brightness allows) to minimize a negative impact on image gray scale smoothness.

In addition to reducing the power consumption when the light source is turned off, when the light source is turned off, the contrast ratio of the display system can also be improved. When the light source is turned off, there is no light to scatter off the DMD and/or DMD structures, which could reduce the contrast ratio.

A value to be used as a threshold for determining if a majority of the pixels in the image exceed a certain brightness level (the decision in block 524) can have a significant impact upon the effectiveness of the light modulation. If the threshold is set too low, then too many pixels may be clipped or limited and the resulting image may have a loss of detail. On the other hand, if the threshold is set too high, then only on a rare occasion would the light source be turned off.

The diagram shown in FIG. 5c illustrates a sequence of events 540 in the use of the spectral characteristics of an image being displayed to modulate the light produced by the light source to compensate for human eye response to light of differing wavelengths and intensities. The sequence of events 540 can begin with the computation of a histogram, preferably, a histogram for each color component, of an image being displayed (block 542). The computation of the histogram can be performed by a controller, a processor, or a custom designed integrated circuit located in the display system. After computing the histogram of the image, the histogram can be analyzed and a compensation algorithm can be applied to determine a needed modulation for each color LED (block 544). The compensation algorithm may be a model of the human eye and can provide compensation for human eye response to different light wavelengths and intensities. The individual color LEDs can then be adjusted based upon the analysis (block 546).

In images wherein a majority of the pixels of a certain color component are significantly brighter than the pixels of the remaining color components, it can be possible to reduce power consumption by reducing light output intensity in the color components with lower intensity requirements. Any necessary adjustments to provide for hue correction can be performed in coordination with the display system to ensure that the image retains precise colors. When an image demands less intensity for a given color, the light intensity for that color may be modulated. With the modulation of a light intensity of a color or a mix of colors, an inversely proportional signal gain can be applied to the display system pulse width modulated signal on a color by color basis. This can be beneficial for the modulation of mixes of colors as primary colors.

The diagram shown in FIG. 5d illustrates a sequence of events 560 in the use of the spectral characteristics of an environment wherein an image is being displayed to modulate light produced by the light source. Rather (or in addition to) than analyzing the image being displayed to gather information regarding any adjustments that can be made to improve image quality or reduce power consumption, an analysis of the environment where the display system is located can be performed. The environment where the display system is located can be sampled by optical sensors that are sensitive to light in the visible spectrum and can be located in the display system. The environment of the display system can be periodically sampled by an optical sensor and analyzed by a processor in the display system (block 562). The analysis can be similar to the analysis of images being displayed in the display system and can include the computation of a histogram of the environment of the display system. From the histogram of the environment wherein the display system is operating, the spectral characteristics can be determined. Then, based upon the spectral characteristics, adjustments can be made to the light source of the display system to optimize image quality (block 564).

The sequence of events 560 can be used to analyze ambient light conditions of the environment of the display system to determine color component intensity and the light source of the display system can be adjusted to set the white point of the images being displayed to provide proper compensation for human eye response. This can be especially effective in environments that are extraordinarily harsh. With proper adjustments to the light source, the images being displayed by the display system can retain a proper white point. Additionally, if the operating environment of the display system is very dark, the output light intensity of the light source can be reduced to reduce power consumption while preserving adequate image quality. Reducing output light intensity in a dark operating environment may actually improve image quality by presenting an image that is not overly bright.

The diagram shown in FIG. 5e illustrates a sequence of events 580 in the use of an operating mode of the display system to modulate light produced by the light source. Depending upon an operating mode of the display system, there can be different requirements for power consumption by the display system. For example, if the display system is operating on battery power, then it may be desired that power consumption be reduced to extend continuous operating time of the display system as long as possible. The sequence of events 580 can begin with a determination of an operating mode of the display system (block 582). The determination of the operating mode can be made by detection circuitry that can determine if the display system is making use of AC power or is being powered by batteries. The detection circuitry may be a part of the power supply of the display system, which upon detecting the power mode of the display system, may write a specified value into a memory location or register that denotes the power mode of the display system. A different method for denoting operating modes may be involved if the display system can have more than a few operating modes. For example, if the display system may have custom display modes that can be preprogrammed by the manufacturer or programmed by the user, a memory location or a bank of memory locations can be used to permit the storage of the various parameters for the different display modes. The determination of the operating mode (block 582) can be made by accessing the memory location (or bank of memory locations).

If the operating mode (display mode) of the display system requires (or desires) low power consumption (block 584), to either extend the continuous operating time of the display system or to extend the useful life of the light source, for example, then the output light intensity of the light source can be reduced (block 586). According to a preferred embodiment of the present invention, the output light intensity of the light source can be reduced by reducing a drive current used to illuminate the LEDs in the light source. Alternatively, it can be possible to reduce the output light intensity of the LEDs by changing a duty cycle of the drive current. Furthermore, if more than one LED is used to provide light for the light source, output light intensity can be reduced by reducing a number of LEDs used to provide light. For example, it is possible to substantially reduce output light intensity by 50 percent by halving the number of LEDs used to produce light.

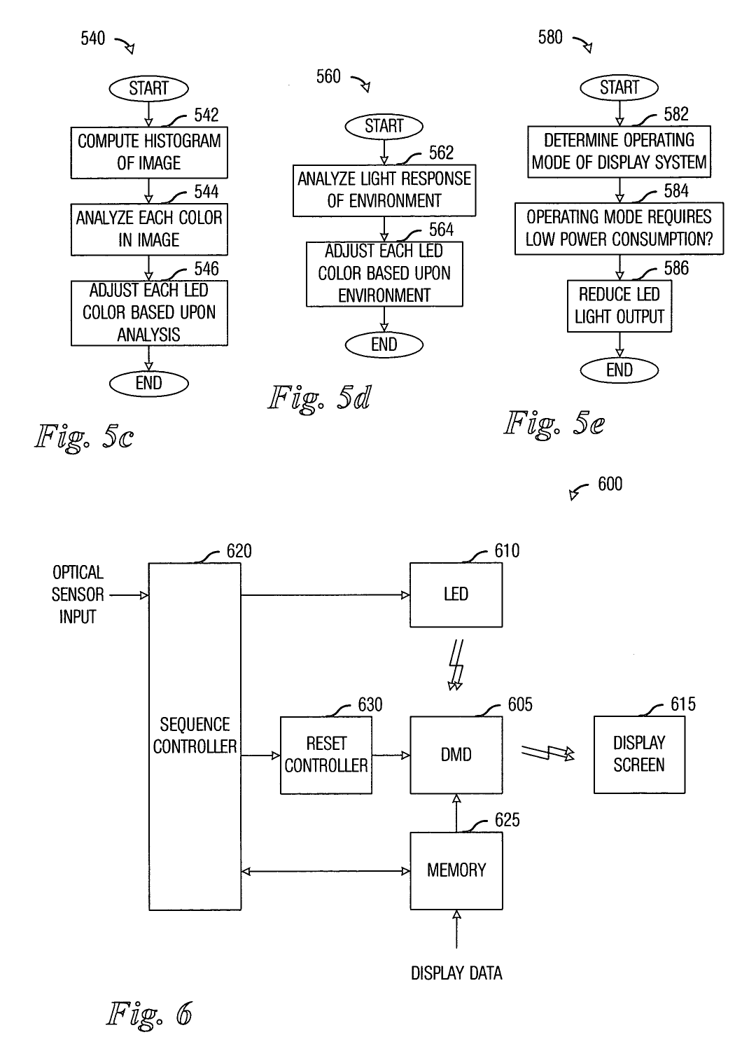

With reference now to FIG. 6, there is shown a diagram illustrating a portion of a display system 600, according to a preferred embodiment of the present invention. As shown in FIG. 6, the portion of the display system 600 includes a spatial light modulator 605, such as a digital micromirror device (DMD) array, and a light source 610 using LEDs. In addition to micromirrors, other light modulator technology, such as liquid crystal, liquid crystal on silicon, deformable mirrors, actuated mirrors, and so forth, can be used in the spatial light modulator 605. The light source 610 should be able to switch from on to off and off to on at a faster rate than the light modulators in the spatial light modulator 605 are capable of changing state. The light source 610 may be a single LED or an array of LEDs. The array of LEDs may be made up of LEDs of a single color or differently colored LEDs may be used. For example, the light source 610 can be implemented as the light source 300 shown in FIG. 3. Furthermore, the light source 610 is capable of producing light at various intensities. Light from the rapid switching light source 610 reflects from the spatial light modulator 610 and onto a display screen 615.

A sequence controller 620 can provide instructions to the light source 610 to control LED state and brightness. The sequence controller 620 can also access a memory 625, which can contain the data (pixel information) of images to be displayed via the spatial light modulator 605. A reset controller 630, also controlled by instructions provided by the sequence controller 620, places the spatial light modulator 605 into a mode that allows it to accept new state change instructions from the sequence controller 620. In addition to providing instructions to the light source 610 and the spatial light modulator 605, the sequence controller 620 can also be used to compute spectral characteristics of images being displayed, with the images being stored in the memory 625. Furthermore, the sequence controller 620 can execute analysis algorithms and models that can be used to determine the type and magnitude of modulations to be made to the LEDs in the light source 610. The sequence controller 620 can also have an input from an optical sensor (optical sensor not shown) that can provide information regarding the operating environment of the display system 600.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for operating a display system, the method comprising:
computing a set of spectral characteristics;
analyzing the set of spectral characteristics; and
modulating a light produced by a light source of the display system based upon the analysis, wherein the light source is capable of rapidly switching and is modulatable.

2. The method of claim 1, wherein the spectral characteristics are computed from images as they are being displayed by the display system.

3. The method of claim 2, wherein the spectral characteristics are computed prior to an image being displayed by the display system.

4. The method of claim 1, wherein the spectral characteristics are computed from a sampling of an operating environment of the display system.

5. The method of claim 4, wherein an optical sensor provides samples of the operating environment.

6. The method of claim 1, wherein the analysis determines that more than a specified number of pixels have an intensity of less than a specified threshold, and wherein the modulating comprises turning off the light source for a period of time substantially equal to a display time required to display pixels exceeding the specified threshold.

7. The method of claim 6, wherein pixels having an intensity of greater than the specified threshold are displayed with an intensity substantially equal to the specified threshold.

8. The method of claim 6, wherein the modulating comprises turning off the light source for a period of time less than the display time and turning the light source off for the display of pixels with very low intensities, wherein a sum of the time that the light source is off is substantially equal to the display time required to display pixels exceeding the specified threshold.

9. The method of claim 1, wherein each pixel in an image comprises a plurality of color components, wherein the analysis analyzes each color component of each image, and wherein the modulating comprises modulating each color component of the light.

10. The method of claim 9, wherein the modulating comprises adjusting a hue of a color component.

11. The method of claim 1 further comprising prior to the modulating, determining an operating mode of the display system.

12. The method of claim 11, wherein the modulating comprises reducing an intensity of the light in response to a determination that the display system is operating on battery power.

13. The method of claim 11, wherein the modulating comprises reducing an intensity of the light in response to a determination that the display system is operating in a low power mode.

14. The method of claim 1, wherein the display system makes use of a spatial light modulator, and wherein the modulating comprises turning on the light source for a period of time that is less than a shortest amount of time that the spatial light modulator can use to represent a single state.

15. A display system comprising:
a spatial light modulator, the spatial light modulator configured to create images comprised of pixels by setting each light modulator in an array of light modulators into a state matching a corresponding pixel value;
a rapid switching and modulatable light source (RSMLS) to optically illuminate the spatial light modulator, the RSMLS capable of switching at a faster rate than a rate of state switching for light modulators in the spatial light modulator and producing a light of specifiable intensity and color.

16. The display system of claim 15 further comprising a display screen to display the images reflected from the spatial light modulator.

17. The display system of claim 15, wherein the spatial light modulator comprises an array of micromirrors.

18. The display system of claim 15, wherein the spatial light modulator comprises an array of deformable mirrors.

19. The display system of claim 15, wherein the RSMLS comprises a light-emitting diode (LED).

20. The display system of claim 19, wherein the RSMLS comprises a plurality of LEDs.

21. The display system of claim 20, wherein the RSMLS comprises different colored LEDs.

22. The display system of claim 19, wherein the LED is a phosphor coated LED.

23. The display system of claim 21, wherein the RSMLS comprises:
a first LED configured to produce a first color component of the light;
a first lens positioned between the first LED and a light output of the RSMLS, the first lens to focus light produced by the first LED;
a second LED configured to produce a second color component of the light;
a second lens positioned between the second LED and a first filter, the second lens to focus light produced by the second LED and the first filter to pass light produced by the first LED and to reflect light produced by the second LED;
a third LED configured to produce a third color component of the light; and
a third lens positioned between the third LED and a second filter, the third lens to focus light produced by the third LED and the second filter to pass light produced by the first LED and the second LED and to reflect light produced by the third LED.

24. The display system of claim 23, wherein the first filter further rejects a portion of a light spectrum of light produced by the first LED, and wherein the second filter further rejects a portion of a light spectrum of light produced by the second LED.

25. The display system of claim 15, wherein the RSMLS comprises a laser.
